(19) United States
(12) Patent Application Publication
(10) Pub. No.: US 2006/0007693 A1
(43) Pub. Date: Jan. 12, 2006

(54) Front light for a bicycle

(76) Inventor: Theo H. Grepper, GRENG (CH)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/527,445

(22) PCT Filed: Sep. 5, 2003
(86) PCT No.: PCT/EP03/09876

§ 371 Date: Mar. 9, 2005

(30) Foreign Application Priority Data
Sep. 12, 2002 (DE) 202 14 095.4

(51) Int. Cl. B62J 6/00

(52) U.S. Cl. 362/474; 362/473; 362/486

(57) ABSTRACT

Front light for a bicycle with a light housing, an electrical illuminating means arranged therein behind a light outlet port, a fastening device for fastening the light housing to a bicycle and a minicomputer arranged in the light housing with a computer display on an exterior face of the light housing.

The invention relates to a front light for a bicycle.

Front lights for bicycles are known which are powered by an electric dynamo. Moreover, front lights for bicycles are known which have a power supply from batteries or rechargeable batteries. Furthermore, there are front lights for bicycles with batteries or rechargeable batteries which have a plug-in or clamp fastening. To avoid theft they can be taken away by the cyclist when the bicycle is parked.

Bicycle computers are also known which measure and display speeds, distances, times, navigation data and physiological data of the user. Such bicycle computers also have plug-in or clamp fastenings, so that during breaks they can be easily removed from the bicycle by the cyclist and taken away. These bicycle computers are equipped with an LCD display which can be difficult to read in the dark.

In principle, attaching additional devices to the bicycle is awkward and carrying several devices during breaks is tiresome.

Proceeding from this, the object of the invention is to reduce the cost of mounting and handling front lights for bicycles and bicycle computers and to improve the legibility of bicycle computers in the dark.

This object is achieved by a front light for a bicycle with the features of claim 1. Advantageous embodiments of the front light for a bicycle are disclosed in the sub-claims.

The front light for a bicycle according to the invention has a light housing, an electrical illuminating means arranged therein behind a light outlet port, a fastening device for fastening the light housing to a bicycle and a minicomputer arranged in the light housing and with a computer display on an exterior face of the light housing.

According to the invention, a bicycle computer is incorporated in the front light for a bicycle and the front light for a bicycle comprises a computer display. The front light for a bicycle and the bicycle computer can therefore be attached and removed together. The cost of additional devices and mounting parts is reduced. The electric power supply can also be simplified. Both the illuminating function and the computer function are available to the cyclist.

The electric power supply of the electrical illuminating means and the minicomputer can be produced by means of a bicycle dynamo and an electric control, optionally by using rechargeable batteries. According to an embodiment the electrical illuminating means and the minicomputer are, and/or can be, connected to the same power supply. According to an embodiment, the electrical illuminating means and the minicomputer are connected to at least one electric battery arranged in the light housing and/or an electric rechargeable battery arranged therein. The power supply is then also completely incorporated in the front light for a bicycle.

According to an embodiment the computer display is an LCD display which can operate in a particularly energy-saving manner. According to an embodiment an electrical illuminating means for illuminating the computer display is associated with the computer display in the light housing. The computer display can then be easily read in the dark. According to an embodiment the electrical illuminating means arranged behind the light outlet port is at the same time associated with the computer display and illuminates it. The electrical illuminating means then has the dual function of illuminating the cyclist's path and the computer display. According to an advantageous embodiment a bright halogen lamp or krypton lamp is used as an electrical illuminating means.

In principle, the computer display can comprise an individual housing which is separate from, and rigidly attached to, the light housing, for example via at least one projection. According to an embodiment the computer display is incorporated in the exterior face of the light housing. According to an embodiment the computer display is arranged on the upper face of the light housing. According to an embodiment it is arranged in a desk-like portion of the light housing inclined toward the cyclist.

According to an embodiment the front light for a bicycle is provided with at least one electrical operating device for switching on or off and/or controlling the at least one electrical illuminating means and/or switching on and/or off and/or operating the minicomputer.

According to an embodiment a device for fastening the front light for a bicycle is present on a lower face of the light housing.

The invention will be described hereinafter in more detail with reference to the accompanying drawings of an embodiment, in which:

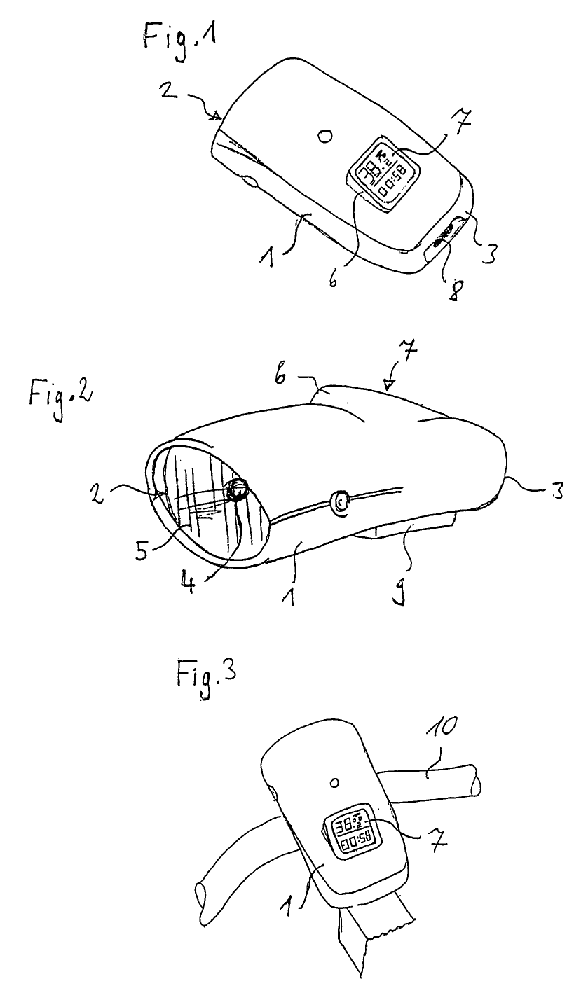

FIG. 1 is an oblique perspective view from above of the front light for a bicycle;

FIG. 2 is a perspective view from the front and from the side of the same front light for a bicycle;

FIG. 3 is an oblique perspective view from above of the same front light for a bicycle mounted on bicycle handlebars.

The front light for a bicycle has a light housing 1 which substantially has the shape of a flattened tube. The light housing 1 has a light outlet port 2 at the front and is closed off at the rear by a housing wall 3.

An electrical illuminating means 4, which for example is a halogen lamp, is located in the light housing 1 behind the light outlet port 2. The electrical illuminating means 4 is, for example, arranged at the focal point of a reflector 5 which opens out toward the light outlet port 2.

On the upper face of the light housing 1 a desk-like portion 6 is located in the rear part which is inclined toward the rear. A computer display 7 is incorporated in the upper face of the desk-like portion 6.

A minicomputer which is not shown in the drawings is, moreover, located in the light housing 1. In this case it is a bicycle computer which is able to measure speeds and/or times and/or distances and/or navigation data and/or physiological data (for example pulse frequency and/or blood pressure) and to display it by means of the computer display 7.

The computer display 7 is for example an LCD display which is illuminated by the electrical illuminating means 4. To this end, in the interior of the light housing 1 light passages of the electrical illuminating means 4 are present on the upper face of the computer display 7 and the illuminating means 4 and computer display 7 are connected via a light guide. In a further embodiment a separate electrical illuminating means is associated with the upper face of the illuminated display. Moreover, a plurality of batteries are located in the light housing 1 which power the electrical illuminating means 4 and the minicomputer and the computer display 7.

A switch 8 which allows the illuminating means 4, the minicomputer and the computer display 7 to be switched on and off is incorporated in the rear wall 3. Further operating elements, not shown, are incorporated in the exterior face of the light housing 1 for operating the minicomputer.

The lower face of the light housing 1 is provided with a conventional mount 9 with a C-slot for pushing onto a bracket of a companion piece fastened to the bicycle.

To measure the speed, the bicycle computer is coupled to a velocity sensor which is not shown in the drawings. The velocity sensor and other sensors, for example to measure physiological data, are preferably connected via the mount 9 and the contacts incorporated therein.

FIG. 3 shows the front light for a bicycle with the light housing 1 fastened to bicycle handlebars 10 so that the computer display 7 can be observed by the cyclist. Illumination of the computer display 7 is ensured at night. During breaks, the cyclist can easily detach and safeguard the front light for a bicycle with the integral bicycle computer.

1. Front light for a bicycle with a light housing (1), an electrical illuminating means (4) arranged therein behind a light outlet port (2), a fastening device (9) for fastening the light housing (1) to a bicycle and a minicomputer arranged in the light housing (1) with a computer display (7) on an exterior face of the light housing (1).

2. Front light for a bicycle according to claim 1, in which the light housing (1) is substantially tubular with the light outlet port (2) on one end and a housing wall (3) on the other end.

3. Front light for a bicycle according to claim 1, in which the electrical illuminating means (4) and the minicomputer are, and/or can be, connected to the same power supply.

4. Front light for a bicycle according to claim 1, in which the electrical illuminating means (4) and the minicomputer are connected to at least one battery arranged in the light housing (1) and/or at least one rechargeable battery arranged therein.

5. Front light for a bicycle according to claim 1, in which the computer display (7) is an LCD display.

6. Front light for a bicycle according to claim 1, in which an electrical illuminating means (4) for illuminating the computer display (7) is associated with the computer display (7) in the light housing (1).

7. Front light for a bicycle according to claim 6, in which the electrical illuminating means (4) arranged behind the light outlet port (2) is at the same time associated with the computer display (7).

8. Front light for a bicycle according to claim 1, in which the computer display (7) is arranged on the upper face of the light housing (1).

9. Front light for a bicycle according to claim 1, in which the computer display (7) is incorporated in a desk-like portion (6) on the upper face of the light housing (1).

10. Front light for a bicycle according to claim 1, with at least one electrical operating device (8) for switching on and/or off and/or controlling the at least one electrical illuminating means (4) and/or switching on and/or off and/or operating the minicomputer.

11. Front light for a bicycle according to claim 1, with a minicomputer and computer display (7) for measuring and/or displaying a speed and/or a time and/or a distance and/or navigation data and/or pulse frequency and/or blood pressure.

12. Front light for a bicycle according to claim 1, with a fastening device (9) for releasably fastening to a bicycle.

13. Front light for a bicycle according to claim 1 with a fastening device (9) on a lower face of the light housing (1).
